(19) United States
(12) Patent Application Publication
(10) Pub. No.: US 2025/0125438 A1
(43) Pub. Date: Apr. 17, 2025

(54) PLUG FOR A BATTERY BOX FLOOR FOR ELECTRIC VEHICLES

(71) Applicant: AUTOTECH ENGINEERING S.L., Amorebieta-Etxano (ES)

(72) Inventors: Oriol MUNT FERRÀ, Olesa de Montserrat (Barcelona) (ES); Alfredo VERDE SÁNCHEZ, Barcelona (ES); Iñigo TERREROS GALINDEZ, Laudio/Llodio (Álava) (ES); Asier Ibon MEDINA MAESTRO, Galdakao (Bizkaia) (ES)

(21) Appl. No.: 18/694,629

(22) PCT Filed: Sep. 28, 2022
(86) PCT No.: PCT/EP2022/076908

§ 371 Date: Mar. 22, 2024

(30) Foreign Application Priority Data
Sep. 29, 2021 (EP) 21382874.2

(51) Int. Cl. H01M 10/6556; H01M 10/625; H01M 50/249

(52) U.S. Cl. CPC H01M 10/6556; H01M 10/625; H01M 50/249

(57) ABSTRACT

The present disclosure relates to plugs (10) for sealing one or more cooling channels (25) inside a battery box floor (20) for electric vehicles. The present disclosure also relates to a battery box floor (20) including one or more cooling channels (25) sealed with one or more of the plugs (10) and to a battery box comprising such a battery box floor (20). The present disclosure further relates to a method (100) for manufacturing such a battery box floor (20). An elongated plug (10) for sealing one or more cooling channels (25) inside a base plate (32) for a battery box floor (20) for an electrical vehicle (1) comprises an inner piece (11) configured to be in contact with a coolant and an outer piece (12) joined to the inner piece (11) along a longitudinal direction (5) of the plug (10). The outer piece (12) is configured to be attached to a frame (30) of a battery box. The outer piece (12) is stiffer than the inner piece (11).

The present application claims the benefit of EP21382874.2 filed on Sep. 29, 2021.

### TECHNICAL FIELD

The present disclosure relates to plugs for sealing one or more cooling channels inside a battery box floor for electric vehicles. The present disclosure also relates to battery box floors including one or more cooling channels sealed with one or more of the plugs, and to battery boxes comprising such battery box floors. The present disclosure further relates to methods for manufacturing such battery box floors.

### BACKGROUND

Electric vehicles such as an electric car comprise battery boxes for holding and protecting a plurality of battery cells. A battery box is usually arranged between the front and rear axles of the electric vehicle. An electric vehicle is driven at least in part by an electric motor powered by the plurality of battery cells, the cells being configured to store energy. As used herein, an electric vehicle may be electrically driven in their entirety, e.g. as electric vehicles, or an electric vehicle may be partially electrically driven, e.g. as a hybrid vehicle.

The battery cells may for example be lithium-ion batteries, although other types of batteries suitable for powering an electric motor of an electric vehicle may be used. For example, fuel cells or supercapacitors may be used. A battery box may comprise hundreds or thousands of cells. The cells may be grouped into modules, a module including a plurality of cells. The terms “battery”, “battery cell” and “cell” may be used interchangeably herein.

In terms of structure, a battery box usually comprises a floor, a frame surrounding and joined to the battery box floor, and a cover over the floor and frame which is joined to the frame. Between the floor and the cover, a space is provided for the batteries or cells. The battery box floor is configured to support the battery cells and other components of the battery box such as the battery management system (BMS). The battery box floor may help to protect the batteries from impacts from small objects and irregularities in the road. The battery box floor and the battery frame may offer protection against side impacts to the vehicle.

A battery box should be robust enough to protect the batteries from impacts coming from below and/or a side of a vehicle, and as lightweight as possible to reduce the consumption of energy of the vehicle.

In terms of components, a battery box generally comprises a plurality of modules of battery cells, a battery management system (BMS) and a cooling system. The BMS is configured to monitor the cells. For example, the voltage, the current and the temperature of each cell may be measured and compared to predetermined limit values for checking whether the cells are operating within safety limits.

When a battery is discharged, heat is generated. A cooling system is configured to keep the battery box within a suitable temperature range, e.g. between 20 and 40 degrees Celsius (° C.). The cooling system may also help to minimize a temperature difference within the battery box, e.g. to no more than 5° C. The performance of the battery cells may be negatively affected without an appropriate cooling system, or if the cooling system fails for any reason. If the battery cells overheat, they may explode. Cooling the batteries is therefore relevant both for efficiency and for safety.

Cooling channels for cooling the batteries, e.g. configured to carry a liquid coolant, may be provided. Ensuring that the cooling channels do not leak, or at least that leaking is minimized, is important for avoiding or at least minimizing safety issues that may arise if the coolant leaks. For example, the battery cells and other components inside the battery box may be damaged if a coolant leaks outside the cooling channels.

WO 2019/020772 discloses a battery box floor for electric vehicles comprising a battery pack supporting panel, and a plurality of cooling channels.

### SUMMARY

Throughout this disclosure, a longitudinal direction, a vertical direction and a transverse horizontal direction may be defined for providing spatial orientation of a plug for sealing one or more cooling channels inside a battery box floor. These directions are substantially perpendicular among them. Thus, a plug for sealing a plurality of cooling channels within the battery box floor may have a length along the longitudinal direction, a height along the vertical direction and a width along the transverse horizontal direction. A cross-section of the plug may be defined by a plane substantially perpendicular to the longitudinal direction, thus including the vertical direction and the transverse horizontal direction.

Likewise, a battery box floor (and a corresponding battery box) may have a length along a longitudinal direction of the battery box floor, which would be substantially parallel to a driving direction of the vehicle in which the battery box is mounted, a height along the vertical direction and a width along a lateral direction, which would be substantially perpendicular to the driving direction of the vehicle in which the battery box is mounted. A cross-section of the battery box floor may be substantially perpendicular to the longitudinal direction and may include the vertical direction and the lateral direction. In these examples, the battery box floor is substantially parallel to a vehicle floor and the road. In other examples, a battery box floor may be inclined with respect to a vehicle floor. In some examples, a battery box floor may even be substantially perpendicular to a vehicle floor. An inclined battery box floor may be useful for example for trucks.

In an aspect of the disclosure, an elongated plug for sealing one or more cooling channels inside a base plate for a battery box floor for an electric vehicle is provided. The plug comprises an inner piece configured to be in contact with a coolant. The plug further comprises an outer piece joined to the inner piece along a longitudinal direction of the plug. The outer piece is configured to be attached to a frame of a battery box. The outer piece is stiffer than the inner piece.

According to this aspect, a plug for closing one or more open ends of a base plate for a battery box floor, and thereby sealing one or more cooling channels within the base plate, is provided. As the plug comprises an inner portion that is less stiff, i.e. less rigid than, an outer portion, the inner portion may adapt better to an inner surface of the base plate and the outer portion may help to insert and position the inner portion.

Throughout this disclosure, stiffness may be understood as a resistance to deflection. Therefore, the outer piece, which is stiffer than the inner piece, may be more resistant to a deformation in response to an applied force than the inner piece subjected to the same applied force. Stiffness may be measured in N/m (newtons per meter). The inner piece may be more deformable and elastic than the outer piece.

In some examples, the inner piece of the plug may comprise an elastomer. An elastomer may facilitate the inner piece to conform to an inside surface of an end of a base plate. This may increase the sealing of the cooling channels and reduce leaks of the coolant circulating through the channels.

In these or other examples, the outer piece of the plug may comprise a plastic or a metal. A plastic or metallic outer piece may help to position the inner piece inside an end of a cooling plate to be closed. Having a metallic outer piece may also help to attach the closed end of a base plate to a battery box frame in a robust manner. For example, welding, e.g. friction stir welding, may be used. Tightness of a battery box may be increased in this way. Protection of the batteries of the battery box in case of a crash may also be increased by using welding, in particular continuous welding.

In some examples, the outer piece may comprise an aluminum alloy. An aluminum alloy may reduce the weight of the battery box floor. It may also help to protect the battery cells by increasing energy absorption during a crash. If a battery box frame is made of an aluminum alloy as well, joining and end of a battery box floor sealed by the plug may be easier and more effective than when joining plastic-metal and/or when joining two different types of metals.

In some examples, the inner piece and the outer piece may be mechanically attached. Mechanical attachment may enhance the structural integrity of the plug.

In a further aspect of the disclosure, a floor section for a battery box floor is provided. The battery box floor section comprises a base plate and a first plug. The base plate comprises one or more cooling channels inside the base plate. The first plug is a plug as described herein. The first plug closes an end of the base plate, sealing at least in part the one or more cooling channels.

Throughout this disclosure, a section of a battery box floor may be understood as a portion of the battery box floor having sealed cooling channels. When a base plate comprising one or more open ends is completely closed by inserting one or more plugs into the open ends, a floor section is formed. A battery box floor may comprise one or more sections of battery box floor. Each of these sections cover at least part of the width and/or at least part of the length of the floor of the electric vehicle. In some examples, a battery box floor may comprise two or more floor sections if these two floor sections form a battery box floor when joined. In other examples, a single section may form the battery box floor.

Accordingly, depending on which end of a base plate of a battery box floor section the plug is to be installed, a longitudinal direction of the plug may be substantially parallel to a longitudinal direction of the battery box floor (and of the battery box and of the electric vehicle), or to a lateral direction of the battery box floor (and of the battery box and of the electric vehicle). In the first case, an end of the base plate closed by a plug may be attached to a side portion of a battery box frame. In the second case, it may be attached to a front or rear portion of a battery box frame.

In some examples, the base plate of the section of the battery box floor may be an extruded profile, in particular an aluminum extruded profile. The base plate may therefore have two opposite open ends, substantially perpendicular to the direction of extrusion, which need to be closed. Two plugs as described herein, e.g. a first and a second plug, may close the ends of the extruded base plate and form a section of a battery box floor.

Extrusions may enhance energy absorption during a crash, as well as increase strength of a battery box floor without increasing its weight. An extrusion may also help to minimize leakage of a coolant through its cooling channels.

In a further aspect of the disclosure, a battery box floor comprising one or more battery box floor sections as described herein is provided. Having cooling channels inside the battery box floor may help to efficiently cool the batteries while increasing the space available for arranging the batteries.

In some examples, if the battery box floor includes at least two sections of battery box floor, two adjacent floor sections may be joined by welding. Two edges not being closed by a plug, e.g. two edges substantially parallel to the direction of extrusion of a base plate, may be the ones welded. Butt welding may be used. Welding may be continuous. Welding, in particular continuous welding, may increase the strength of attachment between the sections of the battery box floor.

In a further aspect of the disclosure, a battery box comprising a battery box floor as described throughout this disclosure is provided. A battery box floor end comprising one or more plugs as described herein may be attached to a battery box frame, e.g. to a battery box side beam. Attachment may be through welding, e.g. through friction stir welding. Welding may provide a strong attachment between the battery box floor and the battery box frame. It may also increase the robustness of the battery box and may decrease the possibilities of a coolant leaking outside the cooling channels.

In a further aspect of the disclosure, a method for manufacturing a battery box floor as described herein is provided. The method comprises providing a first base plate. The first base plate comprises one or more cooling channels within the first base plate and comprises a first open end. The method further comprises providing a first plug as described throughout this disclosure. The method further comprises inserting the first plug in the first open end of the first base plate, at least partially closing the one or more cooling channels.

Accordingly, a battery box floor or a battery box floor section for an electric vehicle may be manufactured by inserting at least one plug as described herein in an end of a base plate for closing one or more cooling channels. If the first base plate comprises more than one open end, e.g. a second open end, another plug may be inserted into the second end to close it. For example, if the first base plate is an extruded base plate, two plugs may be inserted into the plate: a first plug in a first open end and a second plug in a second open end. A first battery box floor section may therefore be obtained.

If the battery box floor is to comprise more than one battery box floor section, the method may further comprise providing a second base plate comprising one or more cooling channels within the second base plate and comprising a first open end. The method may further comprise providing a first additional plug as described throughout this disclosure and inserting the first additional plug in the first open end of the second base plate. The one or more cooling channels may be closed at least in part. If the second base plate comprises more open ends, more plugs may be used to completely close the channels inside the base plate. Once the cooling channels are completely closed, a second floor section may be obtained.

The method may further comprise joining an edge of the first base plate and an edge of the second base plate. Welding, e.g. continuous welding, may be used. In some examples, two edges not including plugs may be joined. A strong attachment between the base plates may be obtained. This step may, in some examples, be performed after a floor section is obtained, i.e. after the cooling channels of a base plate are completely closed by inserting one or more plugs. In other examples, this step may be made before introducing one or more plugs into a base plate for closing one or more of its ends. Welding along two consecutive edges of the two base plates after being completely closed by one or more plugs may help to increase the attachment between the plug and the base plate end in which it is inserted into.

The method may further comprise joining an end of a base plate closed by a plug to a battery box frame. Welding, in particular friction stir welding, may be used. As a temperature attained with friction stir welding is not so high as with welding in which melting of two pieces to be attached occurs, the plug may be less affected. In particular, the inner piece may be less affected. A tight seal between the cooling channels and a plug may still be provided. Also, the outer piece may not need to provide a separation between the inner piece and a battery box frame, e.g. a side beam of a battery box frame, as large as if other welding techniques involving higher temperatures were used. Therefore, a plug size, in particular a dimension of the plug substantially parallel to a direction in which the cooling channels and a battery box frame are to be separated, can be reduced. Accordingly, more space for cooling channels within the battery box floor would be available. Cooling efficiency may be increased.

### BRIEF DESCRIPTION OF THE DRAWINGS

Non-limiting examples of the present disclosure will be described in the following, with reference to the appended figures, in which:

FIG. 1A schematically illustrates a side view of an example of an electric vehicle.

FIG. 1B schematically illustrates a top view of the electric vehicle of FIG. 4.

FIG. 2 schematically illustrates a perspective view of an example of a plug for sealing one or more cooling channels within a battery box floor of an electric vehicle.

FIG. 3A schematically illustrates an exploded view of an example of a portion of a battery box comprising the plug of FIG. 2 for sealing a plurality of cooling channels within a base plate of a section of a battery box floor.

FIG. 3B schematically illustrates a perspective view of the portion of the battery box of FIG. 3A after it has been assembled.

FIG. 3C schematically illustrates a cross-sectional view of the portion of the battery box of FIGS. 3A and 3C.

FIG. 4A schematically illustrates a perspective view of an example of a battery box floor comprising four plugs closing a plurality of cooling channels inside the two base plates of the battery box floor.

FIG. 4B schematically illustrates the battery box floor of FIG. 4A without its top portion.

FIG. 5 illustrates a flow chart of a method for manufacturing a battery box floor comprising one or more plugs.

The figures refer to example implementations and are only be used as an aid for understanding the claimed subject matter, not for limiting it in any sense.

### DETAILED DESCRIPTION OF EXAMPLES

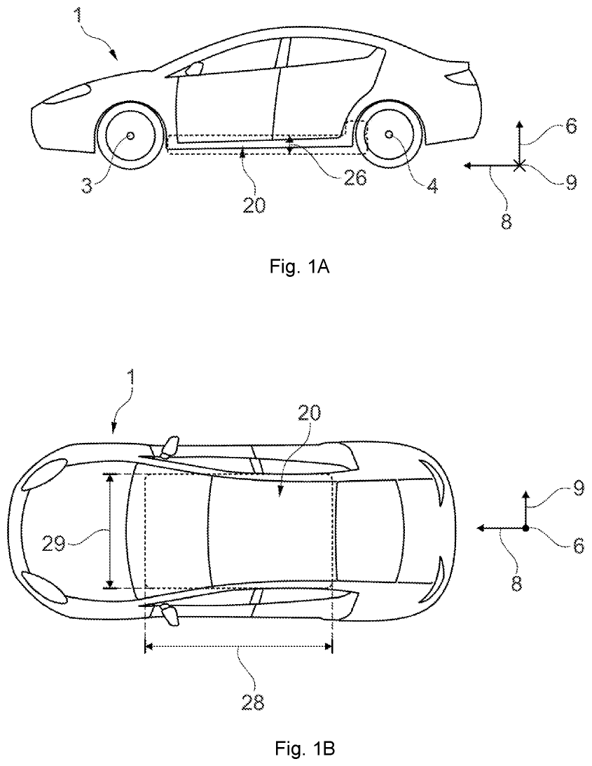

FIGS. 1A and 1B schematically represent an example of an electric vehicle 1. A battery box floor 20 has been indicated by dashed lines in these figures. In this example, the electric vehicle is a car. Other electric vehicles, e.g. a bus or a truck, may also comprise a battery box. A battery box is usually arranged between the front 3 and rear 4 axles of the electric vehicle 1. The battery box floor 20 is arranged at the lower part of the vehicle 1. The battery box floor 20 reinforces the lower part of the vehicle 1 and protects the battery cells in case of an impact from the side or from below the vehicle.

Directions as used throughout this disclosure with respect to the battery box floor 20 are shown in FIGS. 1A and 1B. A vertical direction 6, a longitudinal direction 8 and a lateral direction 9 of the battery box floor 20 have been indicated in these figures. These directions are also applicable to a battery box and to an electric vehicle 1 comprising the battery box with the battery box floor 20.

Therefore, a battery box floor 20 (and a corresponding battery box) may have a length 28 defined along a longitudinal direction 8 of the battery box floor 20, a height 26 defined along the vertical direction 6 of the battery box floor 20 and a width 29 defined along a lateral direction 9 of the battery box floor 20. In the examples of FIGS. 1A and 1B, the battery box floor 20 is substantially parallel to a vehicle floor and to a road below the vehicle. In other examples, a battery box floor, and therefore a battery box, may be inclined with respect to a vehicle floor and the road below the vehicle. For example, a battery box floor may be inclined, e.g. substantially perpendicular to a vehicle floor, in some trucks.

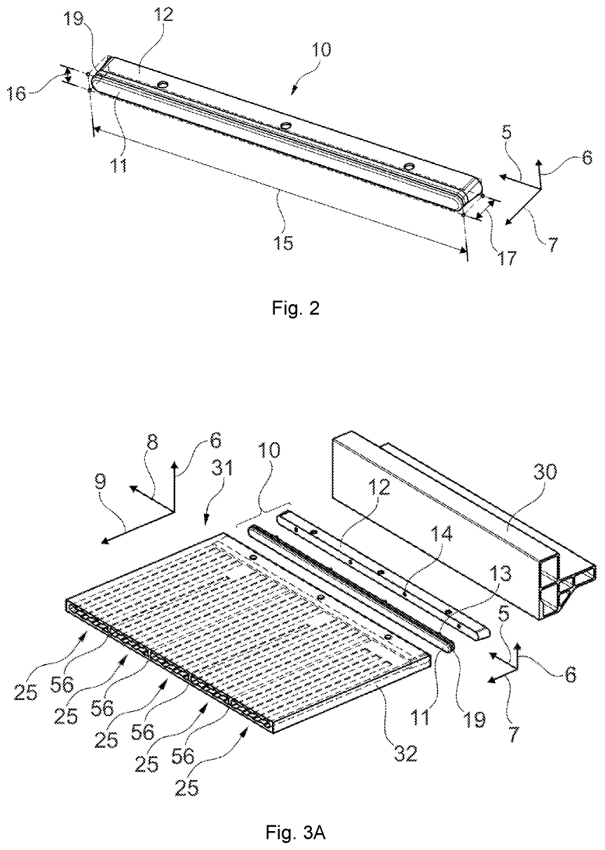

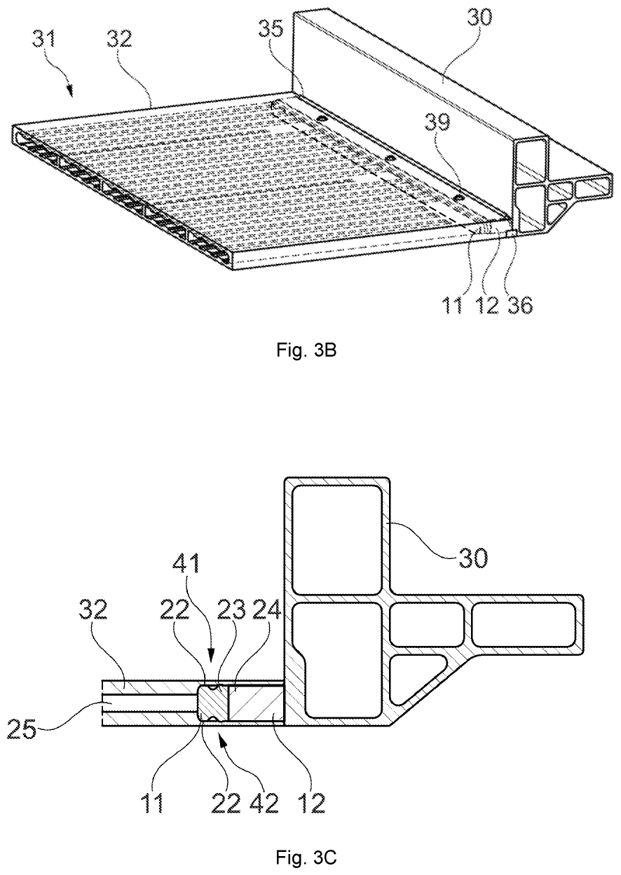

An elongated plug 10 for sealing one or more cooling channels 25 inside a base plate 32 for a floor 20 for a battery box for an electric vehicle 1 is provided. FIG. 2 schematically shows an example of such a plug 10. FIG. 3A schematically illustrates an exploded view of an example of a portion of a battery box comprising the plug of FIG. 2 for sealing one or more cooling channels 25 within a base plate 32 for a floor 20 for a battery box. FIG. 3B schematically illustrates a perspective view of the portion of the battery box of FIG. 3A after it has been assembled. FIG. 3C schematically illustrates a cross-sectional view of the portion of the battery box of FIGS. 3A and 3B. In FIGS. 3A-3C, the base plate 32 comprises a plurality of cooling channels 25, but in other examples, the base plate 32 may comprise a single cooling channel, e.g. a spiraling or serpentine channel.

The plug 10 comprises an inner piece 11 configured to be in contact with a coolant and an outer piece 12 joined, i.e. attached, to the inner piece along a longitudinal direction 5 of the plug 10. The outer piece 12 is configured to be attached to a frame 30 of a battery box. The outer piece 12, or outer portion of the plug, is stiffer than the inner piece 11, or inner portion of the plug.

The inner piece 11 may be configured to be in contact with a coolant and/or may be configured to seal a cooling channel. The inner piece 11 may be resilient or elastic such that it can adapt to an available space. As the inner piece 11 is forced into a space, its shape adapts to the available space in order to provide sealing.

Thus, a plug 10 for sealing one or more cooling channels 25 within a base plate 32 for a battery box floor 20 has a length 15 defined along the longitudinal direction 5 of the plug 10, a height 16 defined along the vertical direction 6 of the plug 10 and a width 17 defined along the transverse horizontal direction 7 of the plug 10. The inner 11 and outer 12 pieces of the plug 10 are attached in a transverse horizontal direction 7 and along a longitudinal direction 5 of the plug 10. A cross-section of the plug 10 may be defined by a plane substantially perpendicular to the longitudinal direction 5, thus including the vertical direction 6 and the transverse horizontal direction 7.

The inner piece or portion 11 of the plug 10 may comprise an elastomer in some examples. As the inner piece 11 is going to be in contact with a coolant flowing through the one or more cooling channels 25, the inner piece 11 is preferably as coolant tight as possible. For example, if a liquid coolant is used, e.g. comprising glycol, the inner piece 11 should prevent or at least reduce to a minimum the passage of the liquid coolant through it. Also, the inner piece 11 should conform to the mating surfaces 22 of a base plate 32 (see FIG. 3C) as much as possible for avoiding or at least minimizing the risk of leakage of the coolant. An elastomer may be a particularly suitable material favoring coolant tightness and conformability to mating surfaces. In some examples, an elastomer may comprise at least one of fluoroelastomer (FKM), nitrile butadiene rubber (NBR), chlorophene rubber (CR), ethylene propylene-diene-monomer rubber (EPDM) and silicone rubber (VMQ). For instance, the inner 11 piece of the plug 10 may comprise FKM in some examples.

In some examples, the outer piece or portion 12 may comprise a plastic or a metal. A plastic or metallic outer piece 12 may have a suitable stiffness for helping to position the inner piece 11 during the insertion of the plug 10. Such an outer piece 12 may also help to increase the coolant tightness of the plug 10 and to avoid, or at least reduce, any leakage of the coolant. A plastic or metallic outer piece 12 may also be suitable to be joined to a frame 30 of the battery box. Joining an outer piece 12 to the frame 30 may be easier and the attachment may be more durable when the outer piece 12 is plastic or metallic. In some examples, an adhesive or a mechanical fastener such as bolts or screws may be used for joining the outer piece 12 to the frame 30.

In particular, a metallic outer piece 12 may be especially suitable for the plug 10. A metallic outer piece 12 may allow welding the outer piece 12 to the frame 30, which may increase the stiffness and the tightness of the battery box in comparison to other ways of attachment. Different types of welding may be used. In some examples, friction stir welding may be used. As friction stir welding softens, but not melts, the elements to be joined, the elements and the surrounding environment may be less affected, e.g. may degrade less, than with other welding techniques.

Accordingly, a plug 10 comprising an elastomeric inner piece 11 and a metallic outer piece 12 may provide a particularly good sealing of the cooling channels integrated in the base plate 32. Attaching the plug 10 to the frame 30 by welding, in particular with friction stir welding, may further increase the tightness of the battery box. Also, as the elastomeric inner piece 11 is not heated, or is at least less heated when friction stir welding is used, a width of the outer piece, and therefore a width 17 of the plug 10, may be decreased. This may leave more room in the base plate 32 for the cooling channels 25, which may increase cooling capability. In addition, stiffness of the battery box may be improved, which may increase the protection of the battery cells in case of an impact against the vehicle, in particular a lateral impact or an impact coming from below the vehicle 1.

In some examples, the metallic outer piece 12 may comprise an aluminum alloy. Using an aluminum alloy may reduce the weight of the outer piece 12 while providing good energy absorption. This may increase the protection of the battery cells in case of a crash without increasing the energy needed to move the electric vehicle. If the outer piece 12 and the frame 30 of the battery box, e.g. a side beam, comprise a metal, in particular a same metal, joining them may be easier. In some examples, both the outer piece 12 and the frame 30 may be made of an aluminum alloy, in particular of an extruded aluminum alloy. In some examples, once the plug 10 is inserted into an open end of a base plate 32, that end may be joined, e.g. welded, to the frame 30.

In some examples, the inner piece 11 and the outer piece 12 may be mechanically attached. Mechanical attachment may be more resistant and durable than other types of attachment. It may also help to increase the sealing ability of the plug 10 than other types of attachment. In some of these examples, for instance as shown in the example of FIG. 3A, at least one of the inner 11 and the outer 12 piece may comprise a plurality of pins 13 and at least the other of the inner 11 and the outer 12 piece may comprise a plurality of receptacles 14 for the pins 13. In the example of FIG. 3A, the inner piece 11 comprises a plurality of pins 13 and the outer piece 12 comprises a plurality of pin receptacles 14. In other examples, the outer 12 and inner 11 pieces may be attached with screws.

In some examples, the inner piece 11 and the outer piece 12 may have a substantially same height. In particular, a height of the inner piece 11 in its side 23 configured to be connected to the outer piece 12 may be substantially the same as a height of the outer piece 12 in its side 24 configured to be connected to the inner piece 11 (see FIG. 3C). In other examples, the outer piece 12 may have a height that is greater than a height of the inner piece 11. For instance, a height of the inner piece 11 in its side 23 configured to be connected to the outer piece 12 may be smaller than a height of the outer piece 12 in its side 24 configured to be connected to the inner piece 11.

In some examples, at least one of a top side 41 and a bottom side 42 of the inner piece 11 may comprise a groove extending along a length 15 of the inner piece 11. In cross-section, a top and/or bottom groove 19 may cause a height of the inner piece 11 to decrease and then to increase along a transverse horizontal direction 7, as shown in FIG. 3C. In some examples, a groove 19 may extend along a total length 15 of the inner piece 11. If there are a top groove and a bottom groove, both grooves may extend along a total length 15 of the inner piece 11. In some examples, a groove may completely surround the inner piece 11. One or more grooves may hinder the leakage of the coolant around the inner piece 11.

The shape and dimensions of the plug 10 may be adapted to an open end of a base plate 32 for a battery box floor 20 in which the plug 10 is to be inserted into. In some examples, the plug 10 may taper towards the inner piece 11. For example, the plug 10 may taper from a face of the outer piece 12 configured to be facing the frame 30 of the battery box to a face of the inner piece 11 configured to be in contact with a coolant. A tapered plug and tapered open end of the base plate may facilitate insertion of the plug. In some examples, only the outer piece 12 may taper. In other examples, only the inner piece 11 may taper. Tapering may be in height 16 and/or may be in length 15.

In some examples, a height 16 of the plug 10 may be between 3 and 20 mm, and more in particular between 5 and 15 mm. In some examples, a width 17 of the plug 10 may be between 12 and 40 mm, and more in particular between 15 and 30 mm. In some examples, a length 15 of the plug 10 may be between 20 and 60 cm, and more in particular between 25 and 40 cm.

In a further aspect of the disclosure, a section 31 for a battery box floor 20 is provided. The battery box floor section 31 comprises a base plate 32 and a plug 10 as described herein. The base plate 32 comprises one or more cooling channels 25 inside the base plate 32. The plug 10 closes an end of the base plate 32, sealing at least in part the one or more cooling channels 25.

As previously explained, a battery box floor 20 may be formed by two or more floor sections 31, as well as by a single floor section 31. A section 31 of a battery box floor 20 includes a base plate 32 and at least one plug 10. If a battery box floor 20 comprises just one floor section 31, referring to the floor section 31 is equivalent to referring to a battery floor box 20.

FIGS. 3A and 3B show an example of end portion of a battery box floor section 31 and a frame 30. In the example of these figures, a portion of a longitudinal 8 side beam 30 of the battery box frame is shown. A plurality of channels 25 extend along a lateral direction 9. In other examples, a plurality of channels 25 may extend along the longitudinal direction 5 of the battery box floor 20. Still in other examples, the plurality of channels 25 may be oriented in other directions, and the channels do not need to be parallel to one another, as in the examples illustrated in the figures. The orientation and routing of the cooling channels 25 within the base plate 32 may be freely chosen in accordance with cooling needs and a plug 10 may be used to seal any kind of cooling channels 25 integrated within a base plate 32 of a battery box floor 20.

Therefore, regardless of the orientation and routing of the cooling channels 25 within a base plate 32, at least one open of the base plate 32 may need to be closed. In the example of FIG. 3A, at least an open end extending along a longitudinal direction 8 needs to be closed. In some examples, an opposite open end may also need to be closed. A plug 10 has been inserted into the open end of the base plate 32 along a lateral direction 9, closing the channels 25. The plug 10 may be inserted such that the outer piece 12 is level, i.e. flush, with the opened end of the base plate 32. The plug may be configured to this end. Clinching 39 or riveting may be used for securing the end of the base plate 32 and the outer piece 12. The battery box floor section 31 and a frame 30 have been also joined, as illustrated in FIG. 3B. A top weld 35 and a bottom weld 36 join the battery box floor section 31 and the frame 30 in this example. Welding may be continuous. Continuous welding may increase the tightness of the battery box. The welds 35, 36 may be performed by friction stir welding.

A base plate 32 of a battery box floor section 31 may in some examples be made of an extruded profile, e.g. of an aluminum alloy extruded profile. Using aluminum reduces the weight of the base plate 32, and thus the weight of the battery box and of an electric vehicle to which the battery box may be mounted to. The use of aluminum may also facilitate creating a plurality of substantially parallel cooling channels 25 inside a base plate 32. Adapting a thickness and/or a shape in cross-section of the substantially cooling channels 25 may also be easier with the use of aluminum alloys and extrusion. In the examples of FIGS. 3A and 3B, the base plate 32 is an extruded profile in which the cooling channels 25 have a rectangular cross-section which is substantially perpendicular to the lateral direction 9. The base plate 32 may be an aluminum alloy extruded profile.

At least in the examples where a base plate 32 is formed by extrusion, two plugs 10 to close two opposite open ends, in particular the two open ends perpendicular to the direction of extrusion, may be needed. For example, a first plug may close a first end of the base plate 32 which is substantially perpendicular to a direction of extrusion of the base plate 32 and a second plug may close a second end of the base plate 32 opposite to the first end. In the example of FIG. 3A, the direction of extrusion is a lateral direction 9. In other examples, the direction of extrusion may be a longitudinal direction 8. Although a plug 10 as described herein may be particularly useful for sealing an extruded base plate 32 of a battery box floor 20, it may be understood that such a plug 10 may be used in other types of base plates 32 for a battery box floor 20 which are not extrusions, but which still need to be sealed.

A battery box floor 20 comprising one or more battery box floor sections 31 as described herein may be provided.

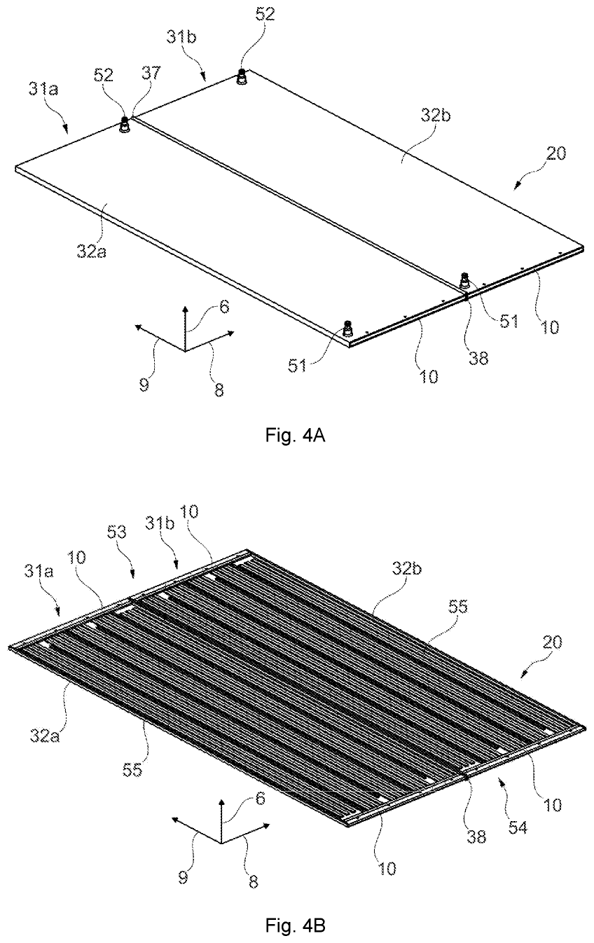

FIG. 4A schematically illustrates a perspective view of an example of a battery box floor 20 comprising two floor sections 31a, 31b. Each battery box floor section 31a, 31b comprises a base plate 32a, 32b with a plurality of cooling channels 25 incorporated therein. Two plugs 10, e.g. a first and a second plug, seal the two open ends of each of the base plates 32. FIG. 4B schematically illustrates the battery box floor 20 of FIG. 4A without its top portion. In FIG. 4B, the plurality of channels 25 comprised in each base plate 32a, 32b may be seen.

In this example, the two floor sections 31a, 31b are welded. A top weld 37 and a bottom weld 38 may be seen in FIG. 4A joining the two floor sections 31a, 31b. In general, two consecutive sections 31a, 31b of a battery box floor 20 may be welded along an edge different from, e.g. substantially perpendicular to, an edge of a base plate 32 closed by a plug 10. FIG. 4A also illustrates a cooling liquid inlet 51 and a cooling liquid outlet 52 for each of the floor sections 31a, 31b. In other examples, the cooling liquid inlets may be the cooling liquid outlets and vice versa. A liquid coolant may be introduced inside a section 31a, 31b of the battery box floor 20 via an inlet 51 and it may twist and turn until reaching an outlet 52.

As the channels 25 have been totally closed by the plugs 10, only one cooling channel 55 remains per floor section 31a, 31b in the examples of FIGS. 4A and 4B. The base plate 32 has been configured to include only one channel 55 once the base plate 32 has been sealed by the plugs 10. The channel 55 has a meandering shape. In other examples, more than one cooling channel 55 may be provided per floor section 31. If the base plate 32 is extruded, the number of cooling channels to remain after closing the base plate 32 with the plugs 10, i.e. per floor section 31, may be chosen by machining the open ends of the base plate 32. For example, one or more end portions of a channel wall 56 may be removed before a plug 10 is inserted (see e.g. FIG. 3A).

A battery box comprising a battery box floor 20 as described herein may be provided. At least and end of a battery box having a plug 10 closing one or more cooling channels 25 may be welded to a frame 30. For example, the two ends 53, 54 of the battery box floor 20 of FIG. 4A, which are closed by plugs 10 and which extend along a longitudinal direction 8 in this figure, may be joined to side beams 30. In some examples, friction stir welding may be used. Welding may be continuous. In other examples, the two ends 53, 54 closed by the plugs 10 may be joined, e.g. welded, to a front frame and a rear frame of the battery box.

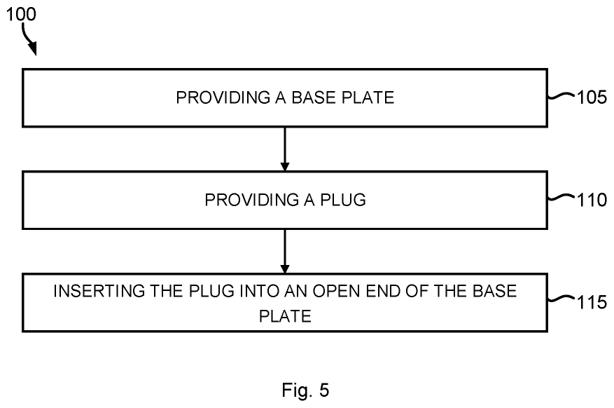

FIG. 5 illustrates a flowchart of a method 100 for manufacturing a battery box floor 20.

The method 100 comprises, at block 105, providing a first base plate 32a comprising one or more cooling channels 25 within the first base plate 32. The first base plate 32a comprises a first open end. The base plate 32a may be an extruded profile, e.g. an aluminum alloy profile. It may therefore be provided by extrusion. If extrusion is used for providing a base plate 32, a die with a suitable cross-sectional profile may be obtained or manufactured first. For instance, a die may be configured to create a base plate 32 comprising a plurality of substantially parallel cooling channels 25. The channels 25 may have a rectangular cross-section in some examples. A die may be made of steel. The die may be preheated to a temperature between 400-600° C. to facilitate an even flow of the material to be extruded, e.g. an aluminum alloy, through the die. Once the die is loaded in an extrusion press, a billet, e.g. an aluminum alloy billet, which may be preheated in order to make it malleable to a temperature e.g. between 400-600° C., may be pushed against and through the die by a ram. An extrusion, e.g. an aluminum alloy extrusion, may come out with a desired cross-section. Cooling, aligning and/or cutting the extrusion may be additionally performed in order to obtain a base plate 32.

Providing a first base plate 32a may further comprise machining the ends of the base plate 32a substantially perpendicular to a direction of extrusion, i.e. two opposite open ends. For example, a cavity for receiving a plug 10 may be created. Some material of the walls 56 separating the channels 25 may also be removed for creating a meandering route for a coolant.

The method 100 further comprises, at block 110, providing a first plug 10 as described herein. An inner piece 11 and outer piece 12 may be first provided and then mechanically attached along a longitudinal direction 5 of the plug 10. In some examples, the inner piece 11 may comprise an elastomer and the outer piece 12 may comprise a metal, e.g. an aluminum alloy. The outer piece 12 may in some examples be obtained by extrusion.

The method 100 further comprises, at block 115, inserting the first plug 10 in the first open end of the first base plate 32a, at least partially closing the one or more cooling channels 25. If the base plate 32a only includes one open end, inserting the first plug 10 may completely close the base plate 32a, a battery box floor section 31 being created. If the base plate 32a includes more than one open end, inserting the first plug 10 would partially close the base plate 32.

The method 100 may further comprise, when the first base plate 32a comprises a second open end, e.g. opposite to the first open end, providing a second plug 10 as described herein. The method may further comprise inserting the second plug 10 in the second open end of the first base plate 32a. Inserting the second plug 10 may totally close the one or more cooling channels 25. For example, if the first base plate 32a is an extrusion, inserting the first and second plugs 10 may completely close the base plate 32a, thereby forming a section 31a for a battery box floor 20.

If the battery box floor 20 is to comprise more than one floor section 31, the previous steps may be repeated to manufacture additional floor sections. For example, the method may further comprise providing a second base plate 32b comprising one or more cooling channels 25 within the second base plate 32b, the second base plate 32b further comprising a first open end. The method may further comprise providing a first additional plug 10 as described throughout this disclosure. The method may further comprise inserting the first additional plug 10 in the first open end of the second base plate, at least partially closing the one or more cooling channels 25.

If the second base plate 32b comprises a second open end, the method may further comprise providing a second additional plug 10 as described herein. The method may further comprise inserting the second additional plug 10 in the second open end of the second base plate.

The method may further comprise joining an edge of the first base plate 32a and edge of the second base plate 32b. In some examples, the two base plates 32a, 32b may be joined along an edge different from, e.g. substantially perpendicular to, an edge of a base plate 32 closed by a plug 10. For example, if the first base plate and the second base plate are extruded profiles, two edges substantially parallel to a direction of extrusion may be joined. This may be seen in the example of FIGS. 4A and 4B, wherein an edge of the first base plate 32a substantially parallel to a direction of extrusion is joined 37, 38 to an edge of the second base plate 32b substantially parallel to a direction of extrusion. In some examples, welding, e.g. continuous welding, may be used. Friction stir welding may be used. A top weld 37 and a bottom weld 38 may be provided. Butt welding may be used for both welds. In some examples, two consecutive base plates may be welded before one or more plugs 30 are inserted in an open end of one of the base plates.

In some examples, joining may be performed after manufacturing two or more floor sections 31a, 31b. In these examples, an edge of a first floor section 31a may be joined to an edge of a second floor section 31b. In some other examples, joining may be performed before closing one or more open ends of the two base plates with plugs 10.

The method may further comprise joining and end of a closed base plate 32 sealed by a plug 10 to a battery box frame 30, e.g. to a longitudinal 8 side beam 30. Friction stir welding may be used. A top weld 35 and a bottom weld 36 may be provided. Corner friction stir welding may be used for the top weld 35. Butt welding may be used for the bottom weld 36.

Once a battery box floor and a battery box frame are assembled, battery cells and other components may be placed on the battery floor. The battery box may be closed by placing a cover over the components supported by the battery box floor and attaching the cover to the battery box frame.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. An elongated plug for sealing one or more cooling channels inside a base plate for a battery box floor for an electric vehicle, the plug comprising:
an inner piece configured to be in contact with a coolant; and
an outer piece mechanically attached to the inner piece along a longitudinal direction of the plug;
wherein the outer piece is configured to be attached to a frame of a battery box; and
wherein the outer piece is stiffer than the inner piece.

2. The elongated plug of claim 1, wherein the inner piece of the plug is made of a material comprising an elastomeric material.

3. The elongated plug of claim 2, wherein the outer piece is made of a material comprising a metal.

4. (canceled)

5. The elongated plug of claim 1, wherein a top side and a bottom side of the inner piece comprise a groove extending along a length of the inner piece.

6. A floor section for a battery box floor comprising:
a base plate comprising one or more cooling channels inside the base plate; and
a first plug closing an end of the base plate, and sealing at least in part the one or more cooling channels, wherein
the first plug comprises
an inner piece made of a material comprising an elastomeric material and configured to be in contact with a coolant; and
an outer piece mechanically attached to the inner piece along a longitudinal direction of the plug;
wherein the outer piece is configured to be attached to a frame of a battery box;
and wherein the outer piece is stiffer than the inner piece.

7. The floor section of claim 6, wherein the base plate is made of an aluminum alloy extruded profile.

8. The floor section of claim 7, wherein the first plug closes a first end of the base plate which is substantially perpendicular to a direction of extrusion of the base plate, and wherein a second plug closes a second end of the base plate opposite to the first end.

9. (canceled)

10. (canceled)

11. (canceled)

12. A method for manufacturing a battery box floor, the method comprising:
providing a first base plate comprising one or more cooling channels within the first base plate, and the first base plate further comprising a first open end;
providing a first plug; and
inserting the first plug in the first open end of the first base plate, at least partially closing the one or more cooling channels, wherein
the first plug comprises
an inner piece made of a material comprising an elastomeric material, which in use is in contact with a coolant in the cooling channels; and
an outer piece which is mechanically attached to the inner piece along a longitudinal direction of the plug;
wherein the outer piece is made of a material comprising a metal or a plastic.

13. The method of claim 12, further comprising:
providing a second base plate comprising one or more cooling channels within the second base plate, the second base plate further comprising a first open end;
providing a first additional plug; and
inserting the first additional plug in the first open end of the second base plate, thereby at least partially closing the one or more cooling channels, wherein
the first additional plug comprises
an inner piece made of a material comprising an elastomeric material, which is use is in contact with the coolant in the cooling channels within the second base plate; and
an outer piece made of a material comprising a metal or a plastic and which is mechanically attached to the inner piece along a longitudinal direction of the plug.

14. The method of claim 13, further comprising joining an edge of the first base plate and an edge of the second base plate.

15. The method of claim 12, further comprising joining the first end of the first base plate closed by the first plug to a battery box frame.

16. The method of claim 15, wherein the joining of the first end of the first base plate to the battery box frame comprises friction stir welding.

17. The method of claim 16, wherein the outer piece of the first plug is made of aluminum extruded profile.

18. The method of claim 12, wherein the first plug includes a groove, the groove extending along an entire circumference of the first plug.

19. The method of claim 12, wherein the inner piece of the first plug and the outer piece of the first plug are joined by screws or bolts.

20. The elongated plug of claim 3, wherein the inner and outer piece of the elongated plug are joined by screws or bolts.

21. The elongated plug of claim 3, wherein the outer piece is made of an aluminum alloy extrusion.
